(19) United States
(12) Patent Application Publication
(10) Pub. No.: US 2026/0336490 A1
(43) Pub. Date: Oct. 29, 2026

(54) MODULE CARRIER ARRANGEMENT

(71) Applicant: Faurecia Autositze GmbH, Hannover (DE)

(72) Inventors: Tomasz Stasinski, Dzierzoniow (PL); Piotr Ceglarek, Katowice (PL); Slawomir Filip, Grabianów (PL); Tomasz Kowalski, Walbrzych (PL); Michal Szott, Grojec (PL)

(73) Assignee: Faurecia Autositze GmbH, Hannover (DE)

(21) Appl. No.: 19/561,756

(22) Filed: Mar. 10, 2026

(30) Foreign Application Priority Data
Apr. 25, 2025 (DE) 102025116028.7

(51) Int. Cl. B60N 2/66; B60N 2/90

(52) U.S. Cl. CPC B60N 2/665; B60N 2/976

(57) ABSTRACT

A module carrier arrangement is used for attachment to the structure of a motor vehicle seat. The module carrier arrangement includes a module carrier in which fluid ducts are integrated for guiding fluid, preferably air. The module carrier has at least one first fastening section and at least one second fastening section. Each first fastening section is designed for fastening a first valve block to the module carrier and each second fastening section is designed for fastening a second valve block different from the first valve block to the module carrier. The first and second fastening sections are arranged on the module carrier in such a way that they allow the fastening of valve blocks of different sizes or model variants to the module carrier.

### BACKGROUND OF THE INVENTION

### Technical Field

The invention relates to a module carrier arrangement.

### Prior Art

Corresponding module carrier arrangements, as are known e.g. from EP 4 349 649 A1, have a module carrier that can accommodate and carries a whole series of usually pneumatic components. It is known to integrate fluid ducts, e.g. air ducts, into such module carriers. Typically, such module carriers are made of a plastics material, such that internal structures can also be molded on or in by common shaping processes such as injection molding or the like. Such module carrier arrangements are then usually connected to the seat structure of a vehicle seat. It is also known that module carriers are used to attach certain components, such as pumps. Fluid-fillable bladders for seat adjustment or massage systems are also usually fastened to such module carriers.

Depending on the equipment of the module carrier arrangement, more or fewer components must be fastened to the module carrier. As a rule, a module carrier tailored to the desired equipping of the module carrier, i.e. the components to be attached, must be manufactured for this purpose. This is a disadvantage because different module carriers have to be manufactured, depending on the requirements profile.

### BRIEF SUMMARY OF THE INVENTION

The object of the present invention is to avoid these disadvantages and to create a module carrier arrangement, with the aid of which a plurality of different equipment variants of a vehicle seat can be realized.

This object is achieved by a module carrier arrangement for attachment to the structure of a motor vehicle seat, wherein the module carrier arrangement includes a module carrier in which fluid ducts are integrated for guiding fluid, preferably air, wherein the module carrier has at least one first fastening section and at least one second fastening section, wherein i) each first fastening section is designed for fastening a first valve block to the module carrier and each second fastening section is designed for fastening a second valve block different from the first valve block to the module carrier, and/or ii) the first and second fastening sections are arranged on the module carrier in such a way that they allow the fastening of valve blocks of different sizes or model variants to the module carrier. Advantageous embodiments can be found in the dependent claims.

The module carrier arrangement according to the invention is characterized in that it already has a high degree of prefabrication, in that fastening sections for a plurality of different valve blocks are already present. This makes it possible to have different equipment variants on the module carrier, since, for example, seat adjustments via fluid-fillable bladders, vibration alarms via fluid-fillable bladders, and massage devices via fluid-fillable bladders can be controlled and supplied via different valve blocks.

According to the invention, the module carrier arrangement for attachment to the structure of a motor vehicle seat has a module carrier in which fluid ducts for guiding fluid, preferably air, are integrated. In this case, the module carrier has at least one first fastening section and at least one second fastening section. Each/the first fastening section is designed for fastening a first valve block to the module carrier, and each/the second fastening section is designed for fastening a second valve block different from the first valve block to the module carrier.

Alternatively or additionally, it may be provided that the first and second fastening sections are arranged on the module carrier in such a way that they make it possible for valve blocks of different sizes or model variants to be fastened to the module carrier. This can be achieved, for example, by arranging fastening sections on the module carrier, preferably on its rear side, in a matrix structure, so that different sections can be used on the module carrier for valve blocks with different external dimensions. Generally, the fastening sections can be fastened to the module carrier, but they can also be molded onto or into the module carrier. This simplifies production.

In the manner described, different equipment variants of a module carrier arrangement according to the invention can be realized with a single module carrier.

According to a preferred embodiment of the present invention, it is provided that a first valve block is attached to at least one first fastening section and/or a second valve block is attached to at least one second fastening section. For example, such a fastening section can be designed as a through-hole, to which a corresponding valve block can then be attached for example using screws or clips, or otherwise without tools or with the aid of tools. Of course, other fastening solutions are also conceivable. Preferably, there is a plurality of first fastening sections and/or a plurality of second fastening sections. Valve blocks can be attached in a particularly secure manner, especially when there is a plurality of fastening sections.

According to a further advantageous development, at least one third fastening section for fastening a fluid pump can be provided on the module carrier. According to one embodiment, a fluid pump is also attached to the third fastening section. The fluid pump can preferably be arranged in such a way that, when fastened to the third fastening section, it is brought into direct connection with a fluid duct.

A further preferred embodiment of the present invention provides, for the module carrier arrangement according to the invention, that bladder fastening sections are provided on the module carrier in the region of one end of the integrated fluid ducts, for fastening fluid-fillable bladders to the module carrier and establishing a fluid-conducting connection between the fluid-fillable bladders and the fluid ducts. Fluid-fillable bladders are flexible structures that can receive a fluid, preferably air within the scope of this invention, and expand in the process or contract when the corresponding fluid is removed from such a bladder. Preferably, these fluid-fillable bladders can be connected to the bladder fastening sections of the module carrier in a fluid-conducting manner via the same existing connection section, either without tools or using a tool. In this case, it may be provided that at least one fluid-fillable bladder is attached to at least one of the bladder fastening sections.

According to a further preferred embodiment of the module carrier arrangement according to the invention, it is possible for the first and/or second fastening sections to be arranged such that when a valve block is being fastened, the respective valve block is automatically connected fluidically to at least one of the fluid ducts. This ensures a highly integrated design of the module carrier according to the invention, and simplifies assembly. Since the fastening sections are usually arranged in such a way that a corresponding valve block is automatically fixed in the correct position when connected to the fastening section, the proper alignment of the valve block with respect to the fluid ducts to be connected to the valve block can also be carried out in this way.

According to a further preferred embodiment of the module carrier arrangement according to the invention, it can be provided that fourth fastening sections are arranged on the module carrier. These fourth fastening sections are designed to receive and fasten a wire suspension on the module carrier. The wire suspension serves to suspend the module carrier from the structure of a motor vehicle seat. The wire suspension usually consists of a bent wire which is passed through the fourth fastening sections. Such fastening sections can be attached to or molded onto the module carrier. This further increases the level of integration.

Different seat requirements may necessitate that wire suspensions of different designs be attached to the same module carrier. Such wire suspensions then have wires that have different curvatures.

In order to make the module carrier, according to the invention, of the module carrier arrangement even more universal, it can be provided that fifth fastening sections that are different from the fourth fastening potions are arranged on the module carrier, which are designed to receive and fasten a wire suspension on the module carrier. Depending on the curvature of the wire, the wire suspension can then be attached to the module carrier via some or all of the fourth fastening sections and via some or all of the fifth fastening sections. Preferably, the module carrier arrangement then has a wire suspension with a wire that is attached to some or all of the fourth fastening sections and/or to some or all of the fifth fastening sections.

Another preferred embodiment of the present invention provides that the integrated fluid ducts are covered in part or completely by a cover or a plurality of covers. In this case, the fluid ducts are present in the module carrier as recesses, and are completed by the aforementioned cover(s). This makes it possible to depict further model variants; for example, recesses for fluid ducts can be provided on the module carrier, of which only some or all ducts are covered by a cover. If, for example, only lumbar adjustment is required, the fluid ducts not required, that are not connected to corresponding bladders, can remain uncovered. The same applies to seats that only require one massage device. For model variants with both of the above-mentioned properties, it is recommended to choose a cover that completely covers all fluid ducts.

Furthermore, the invention relates to a motor vehicle seat with a seat structure, to which a module carrier arrangement according to any of the above embodiments is attached.

### BRIEF DESCRIPTION OF THE DRAWINGS

The invention will be explained in more detail below with reference to FIGS. 1-13.

FIG. 1 shows a first embodiment of a module carrier arrangement according to the invention.

FIG. 2 shows a second embodiment of a module carrier arrangement according to the invention.

FIG. 3 shows a third embodiment of a module carrier arrangement according to the invention.

FIG. 4 shows a fourth embodiment of a module carrier arrangement according to the invention.

FIG. 5 shows a view of a possible embodiment of a module carrier of a module carrier arrangement according to the invention.

FIG. 6 shows a perspective view according to FIG. 5, with valve blocks fastened to the module carrier.

FIG. 7 shows an embodiment of a module carrier with complete coverage of integrated fluid ducts.

FIG. 8 shows an embodiment of a module carrier with partial coverage of integrated fluid ducts.

FIG. 9 shows an embodiment of a module carrier with a first wire suspension.

FIG. 10 shows an embodiment of a module carrier with a second wire suspension.

FIG. 11 shows an embodiment of the module carrier with a plurality of fastening sections.

FIG. 12 shows the module carrier from FIG. 11, to which a first valve block is fastened.

FIG. 13 shows the module carrier from FIG. 11, to which a second valve block is fastened.

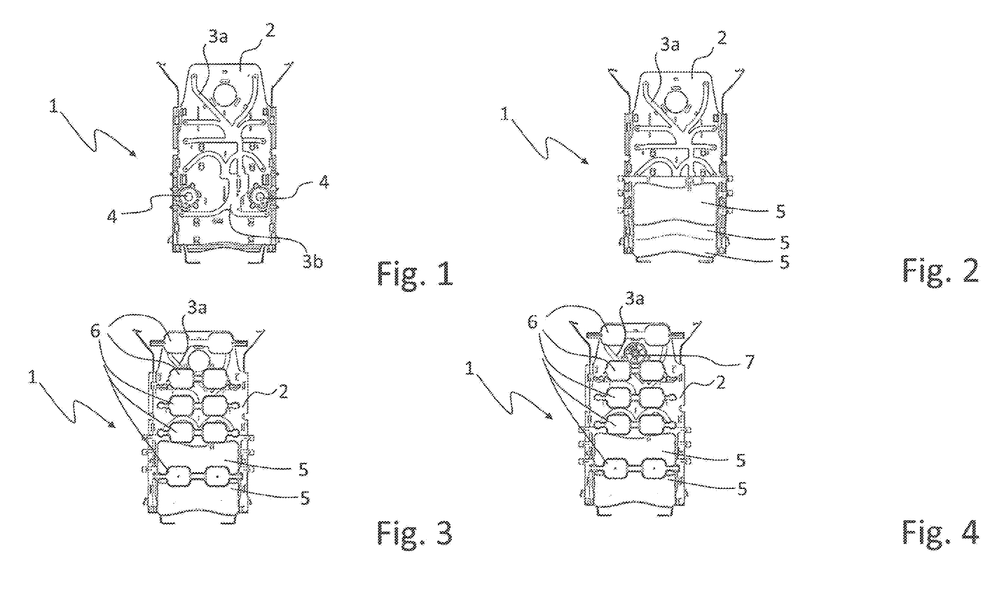

FIGS. 1-4 show different embodiments of a module carrier arrangement 1 according to the invention.

### DETAILED DESCRIPTION OF PREFERRED EMBODIMENTS

In FIG. 1, the module carrier arrangement 1 has a module carrier 2 in which the air ducts 3a, 3b are integrated. In addition, vibration elements 4 are provided, which are attached to the module carrier 2, for example in the form of fluid-fillable bladders or also electrical vibration elements. These vibration elements 4 serve, for example, to output haptic signals to the seat occupant who is sitting in the motor vehicle seat in which the module carrier arrangement 1 is housed. Such haptic signals can, for example, indicate a dangerous situation.

FIG. 2 shows a module carrier arrangement 1 which, in addition to the air ducts 3a, has a plurality of fluid-fillable bladders 5, which serve here as lumbar adjustment bladders for adjusting and adapting the seating comfort in the lower back region. These bladders 5 are supplied or emptied via the air ducts 3a.

FIG. 3 shows an exemplary embodiment in which the module carrier arrangement has, in addition to the lumbar bladders 5, further fluid-fillable bladders 6, which are also arranged on the module carrier 2 and are fluidically connected to the air ducts 3a.

Finally, in the exemplary embodiment shown in FIG. 4, an embodiment is shown in which, in addition to the configuration according to FIG. 3, a seat ventilation system, shown here as a fan 7, is also integrated into the module carrier 2.

It is immediately obvious that it is advantageous if all the aforementioned variants could be implemented using the same module carrier 2. For this purpose, the corresponding module carrier 2 must be pre-configured in a specific way; in particular, it must be able to receive different components 4, 5, 6, 7 separately or simultaneously. This also presupposes, above all, that the air guidance system is sometimes relatively complicated, such that the integration of air ducts 3a, 3b alone is not sufficient to be able to fundamentally represent the different functionalities.

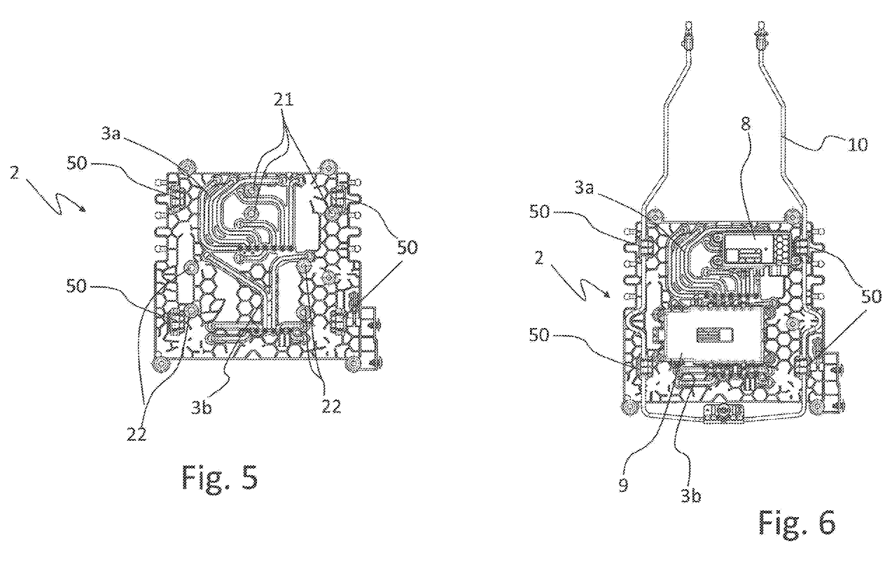

For this reason, according to the invention, a module carrier 2 is proposed, as shown in a variant by way of example in FIGS. 5 and 6. The integrated air ducts 3a, 3b and fastening sections 21, 22 can again also be seen there. In the example shown, these fastening sections 21, 22 are realized by holes integrated in the carrier 2. Other implementation options are of course also conceivable, such as tabs, clips or the like. 50 designates fastening sections for fastening a wire suspension 10 (see FIG. 6). These fastening sections, like the other fastening sections described above or in the following, can also be an integral part of the module carrier 2 in that they are molded onto or into it, or of course they can also be fastened to the module carrier 2 in other ways.

As can be seen in FIG. 6, a first valve block 8 is attached to first fastening sections 21, and a second valve block 9 is attached to the second fastening sections 22. The valve blocks 8, 9 contain pneumatic switching elements such as valves or the like, via which the supply of fluid, preferably air, to the air ducts 3a, 3b takes place. Depending on the application, it may be provided, for example, that a lumbar adjustment is operated via one valve block 8 and a massage device via the second valve block 9. Accordingly, the spatial arrangement of the valve blocks 8, 9 is such that they establish a fluidic connection to corresponding air ducts 3a, 3b, which are integrated in the module carrier 2. The fastening sections 50 hold the wire 10 of the wire suspension, with which the module carrier 2 shown can be attached to the structure of a vehicle seat. The fastening sections 50 may be openings, clips or other feed-throughs suitable for holding and fixing the wire 10 of a wire suspension.

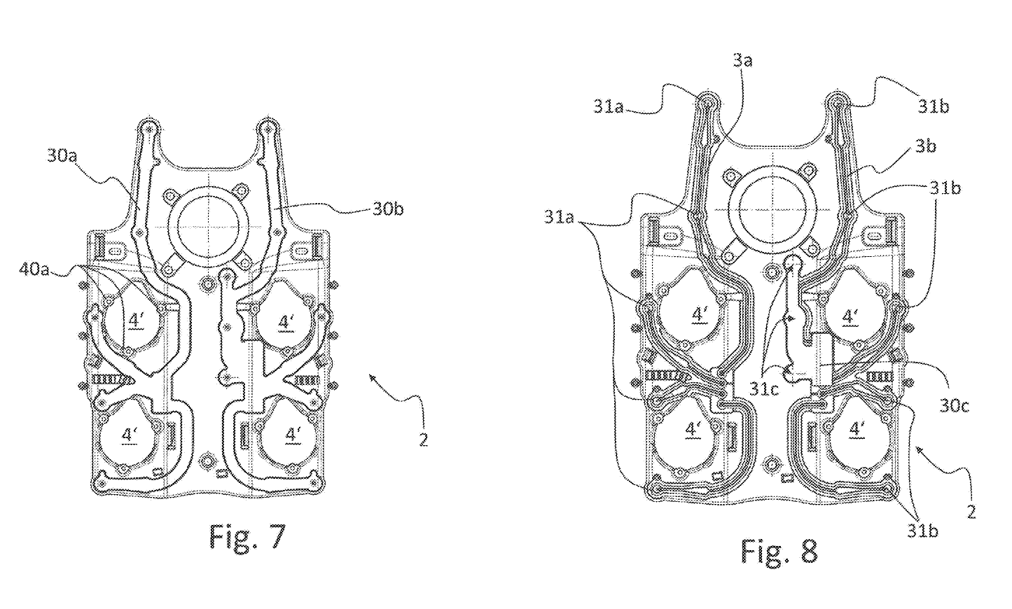

With reference to FIGS. 7 - 13, further properties and variants of the module carrier arrangement according to the invention are described, which can be realized individually on a module carrier arrangement but can also be present in any combination. The embodiments shown in FIGS. 7 - 13 are therefore no more limited than those in the preceding figures to the embodiment shown in each case.

Preferably, the fluid ducts 3a, 3b are integrated into the module carrier 2. This can be a complete integration or – as indicated for example in FIGS. 7 and 8 – ducts 3a, 3b can be incorporated into the module carrier 2 as recesses, which are then covered with a cover 30a, 30b, 30c.

In FIG. 7, the ducts 3a, 3b integrated in the module carrier 2 are completely covered with corresponding covers 30a, 30b. Recesses 4', with fastening elements 40a at their edge, to which, for example, vibration elements 4 (see description of FIG. 1) can be fastened, are also visible. However, there are also variants in which only some of the ducts 3a, 3b prefabricated in the module carrier 2 are used; in such a case (FIG. 8), even only some of the ducts 3b are covered by a cover 30c. In the example shown in FIG. 8, for example the ducts 3a and 3b are used mainly for the installation of a possible massage system, while part of duct 3b is used for lumbar adjustment. 31a and 31b as well as 31c are bladder fastening sections arranged or preformed in the module carrier 2. The bladder fastening sections 31a, 31b are used, for example, for fastening massage bladders, while the bladder fastening sections 31c are used for fastening bladders for lumbar adjustment. Depending on the desired embodiment, all of these mentioned bladder fastening sections 31a to 31c can be connected to bladders; it is equally conceivable for only some of the bladder fastening sections to be fitted with bladders at all.

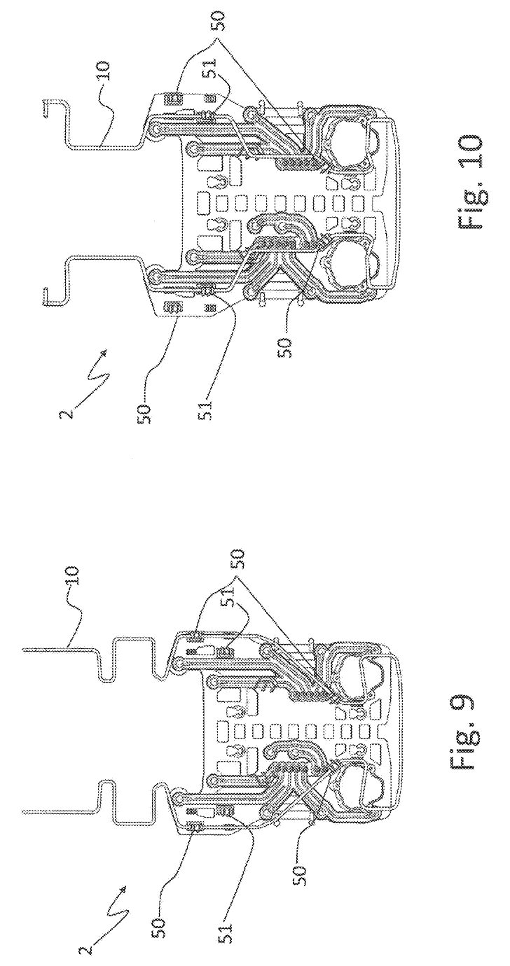

FIGS. 9 and 10 show an embodiment in which different fastening sections 50, 51 for a wire 10 of a wire suspension are arranged or formed on the module carrier. Wire suspensions serve to attach the module carrier arrangement according to the invention or the module carrier to a structural part (not shown here) of a motor vehicle seat. This type of suspension ensures a certain flexibility or elasticity. Depending on the vehicle type and seat type, different requirements are placed on this type of suspension. For example, it may be necessary to also guide the wire differently with regard to the equipping of module carrier 2, which requires a different wire curvature in different directions. Due to the design, it may therefore be the case that the fastening sections 50 shown in FIG. 9 cannot always be connected to the wire 10, because other components interfere with this connection or the desired elasticity is not achieved. As can be seen in FIG. 9, only the fastening sections 50 are used here to hold the wire 10. In the case of a correspondingly different curvature of the wire, i.e. a different guidance of the wire 10, it may be necessary to use additional fastening sections 51 (FIG. 10). In order to respond to these different requirements with regard to a universal equipping of a module carrier 2, the invention proposes, in the embodiment shown in FIGS. 9 and 10, to provide different fastening sections 50, 51 on the module carrier.

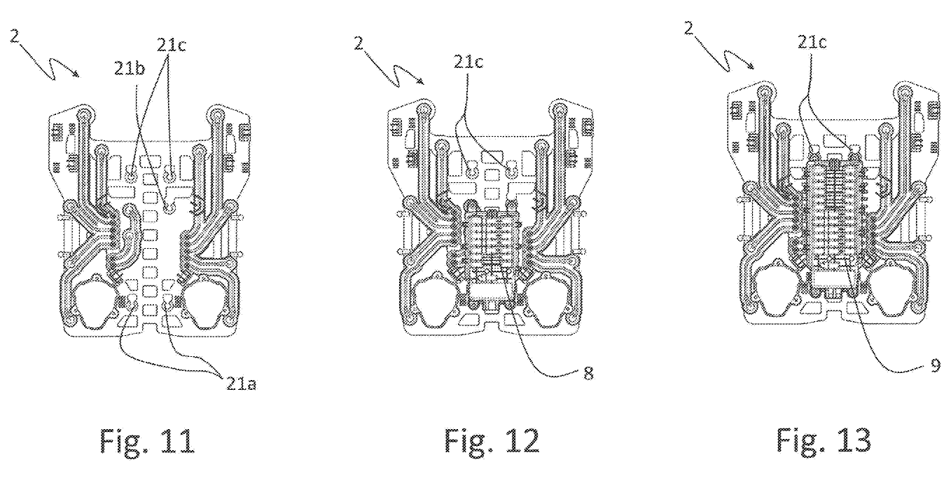

Finally, FIGS. 11 - 13 show a module carrier 2 of the module carrier arrangement according to the invention, which has different fastening sections 21a to 21c. These fastening sections are used to fasten different valve blocks 8, 9. In the embodiments shown in FIGS. 11 - 13, the fastening sections 21a and 21b (FIG. 11) serve to fasten a first valve block 8 (FIG. 12). Accordingly, the fastening sections 21a and 21c (FIG. 11) serve here to fasten a valve block 9 which differs from valve block 8 in terms of design, construction or size.

In this way, the module carrier 2 can already be adapted during manufacture, for the attachment of valve blocks 8, 9 of different design or size. In the case of valve block 8, the fastening sections 21c are unused; in the case of valve block 9, the fastening sections 21b are unused. In principle, all fastening sections are either molded onto, molded into, or fastened to the module carrier 2.

The described embodiment of the module carrier according to the invention therefore makes it possible to realize a plurality of different variants of a module carrier arrangement with the same module carrier, which saves costs in manufacture, since only one type of module carrier has to be manufactured.

What is claimed is:

1. A module carrier arrangement (1) for attachment to the structure of a motor vehicle seat, wherein the module carrier arrangement (1) includes a module carrier (2) in which fluid ducts (3a, 3b) are integrated for guiding fluid, preferably air, wherein the module carrier (2) has at least one first fastening section (21; 21a; 21b) and at least one second fastening section (21c; 22), wherein
i) each first fastening section (21; 21a; 21b) is designed for fastening a first valve block (8) to the module carrier (2) and each second fastening section (21c; 22) is designed for fastening a second valve block (9) different from the first valve block (8) to the module carrier (2), and/or
ii) the first and second fastening sections (21, 22; 21a; 21b; 21c) are arranged on the module carrier (2) in such a way that they allow the fastening of valve blocks (8, 9) of different sizes or model variants to the module carrier (2).

2. The module carrier arrangement (1) according to claim 1, wherein the first valve block (8) is attached to at least one first fastening section (21) and/or the second valve block (9) is attached to at least one second fastening section (22).

3. The module carrier arrangement (1) according to claim 1, further comprising at least a third fastening section for fastening a fluid pump, the at least a third fastening section being provided on the module carrier (2).

4. The module carrier arrangement (1) according to claim 3, further comprising a fluid pump attached to the third fastening section.

5. The module carrier arrangement (1) according to claim 1, further comprising bladder fastening sections for fastening fluid-fillable bladders (6) to the module carrier (2) and creating a fluid-conducting connection between the fluid-fillable bladders (6) and the fluid ducts, the bladder fastening sections being provided on the module carrier (2) in the region of one end of the integrated fluid ducts (3a, 3b).

6. The module carrier arrangement (1) according to claim 5, further comprising at least one fluid-fillable bladder (6) attached to at least one of the bladder fastening sections.

7. The module carrier arrangement (1) according to claim 1, wherein the first and/or second fastening sections (21, 22) are arranged such that when a valve block (8, 9) is fastened, the respective valve block (8, 9) is automatically fluidically connected to at least one of the fluid ducts (3a, 3b).

8. The module carrier arrangement (1) according to claim 3, further comprising fourth fastening sections (50) are arranged on the module carrier (2), which are designed to receive and fasten a wire suspension (10) on the module carrier (2).

9. The module carrier arrangement (1) according to claim 8, further comprising fifth fastening sections (51), different from the fourth fastening sections, arranged on the module carrier (2), which are designed to receive and fasten a wire suspension (10) on the module carrier (2).

10. The module carrier arrangement (1) according to claim 1, wherein the integrated fluid ducts (3a, 3b) are covered in part or completely by a cover (30a, 30b, 30c) or a plurality of covers (30a, 30b, 30c).

11. A motor vehicle seat having a seat structure to which a module carrier arrangement (1) according to claim 1 is attached.
